(19) United States
(12) Patent Application Publication
(10) Pub. No.: US 2026/0021729 A1
(43) Pub. Date: Jan. 22, 2026

(54) CHARGING SYSTEM

(71) Applicant: TOYOTA JIDOSHA KABUSHIKI KAISHA, Toyota-shi Aichi-ken (JP)

(72) Inventors: Hironaga ONO, Toyota-shi Aichi-ken (JP); Ritsu NISHIMURA, Nagoya-shi Aichi-ken (JP); Hiroaki NISHINO, Toyota-shi Aichi-ken (JP); Yohei ONO, Nisshin-shi Aichi-ken (JP); Ryohei CHINO, Nisshin-shi Aichi-ken (JP); Shimpei ISOBE, Nisshin-shi Aichi-ken (JP); Manabu HIROSE, Okazaki-shi Aichi-ken (JP)

(73) Assignee: TOYOTA JIDOSHA KABUSHIKI KAISHA, Toyota-shi Aichi-ken (JP)

(21) Appl. No.: 19/268,126

(22) Filed: Jul. 14, 2025

(30) Foreign Application Priority Data
Jul. 18, 2024 (JP) 2024-115048

(51) Int. Cl. B60L 53/36; B25J 18/00; B60L 53/16; B60L 53/18; B60L 53/31

(52) U.S. Cl. CPC B60L 53/36; B25J 18/00; B60L 53/16; B60L 53/31; B60L 53/18

(57) ABSTRACT

A charging system includes: a charger having a charging connector; an arm mechanism that grasps the charging connector; and, a control device for controlling the charger, the arm mechanism and a plurality of vehicles. Further, the control device identifies positions of the vehicles where a time for inserting the charging connector into charging ports of the vehicles is minimized based on an arm locus illustrating a locus when the arm mechanism grasps the charging connector, shapes of the vehicles, and positions of the charging ports of the vehicles, causes the vehicles to automatically travel to the identified positions and park therein, and inserts the charging connector grasped by the arm mechanism into the charging ports to start charging.

### CROSS-REFERENCE TO RELATED APPLICATION(S)

The present application claims priority to and incorporates by reference the entire contents of Japanese Patent Application No. 2024-115048 filed in Japan on Jul. 18, 2024.

### BACKGROUND

The present disclosure relates to a charging system. Japanese Patent No. 6497478 discloses a charging system that uses an arm mechanism and a charger to charge a plurality of vehicles.

### SUMMARY

There is a need for providing a charging system capable of charging two or more vehicles at the same time with a simple configuration and increasing the rotation rate of the charging regardless of the position of the charging port of the vehicle and the type of parking lot.

According to an embodiment, a charging system includes: a charger having a charging connector; an arm mechanism that grasps the charging connector; and, a control device for controlling the charger, the arm mechanism and a plurality of vehicles. Further, the control device identifies positions of the vehicles where a time for inserting the charging connector into charging ports of the vehicles is minimized based on an arm locus illustrating a locus when the arm mechanism grasps the charging connector, shapes of the vehicles, and positions of the charging ports of the vehicles, causes the vehicles to automatically travel to the identified positions and park therein, and inserts the charging connector grasped by the arm mechanism into the charging ports to start charging.

### BRIEF DESCRIPTION OF THE DRAWINGS

FIG. 1 is a block diagram illustrating a schematic configuration of a charging system according to the embodiment;

FIG. 2 is a perspective view illustrating a schematic configuration of a charging system according to the embodiment;

FIG. 3 is a plan view illustrating a schematic configuration of a charging system according to the embodiment;

FIG. 4 is a side view illustrating a schematic configuration of a charging system according to the embodiment;

FIG. 5 is a schematic diagram illustrating the overall flow of the charging method the charging system according to the embodiment executes;

FIG. 6 is a charging system according to the embodiment, using the arm mechanism is a schematic diagram illustrating an example of a case of simultaneously charging two vehicles;

FIG. 7 is a charging system according to the embodiment, using the arm mechanism is a schematic diagram illustrating an example of a case of simultaneously charging two vehicles; and

FIG. 8 is a flowchart illustrating the overall flow of the charging method charging system according to the embodiment executes.

### DETAILED DESCRIPTION

In the technique disclosed in Japanese Patent No. 6497478, regardless of the position of the charging port of the vehicle or the type of parking lot, there is room for improvement in terms of increasing the rate of rotation of charging to the vehicle.

A charging system according to an embodiment of the present disclosure will be described with reference to the drawings. In addition, components in the following embodiments include those which can be substituted and easily by those skilled in the art, or those which are substantially the same.

### Charging System

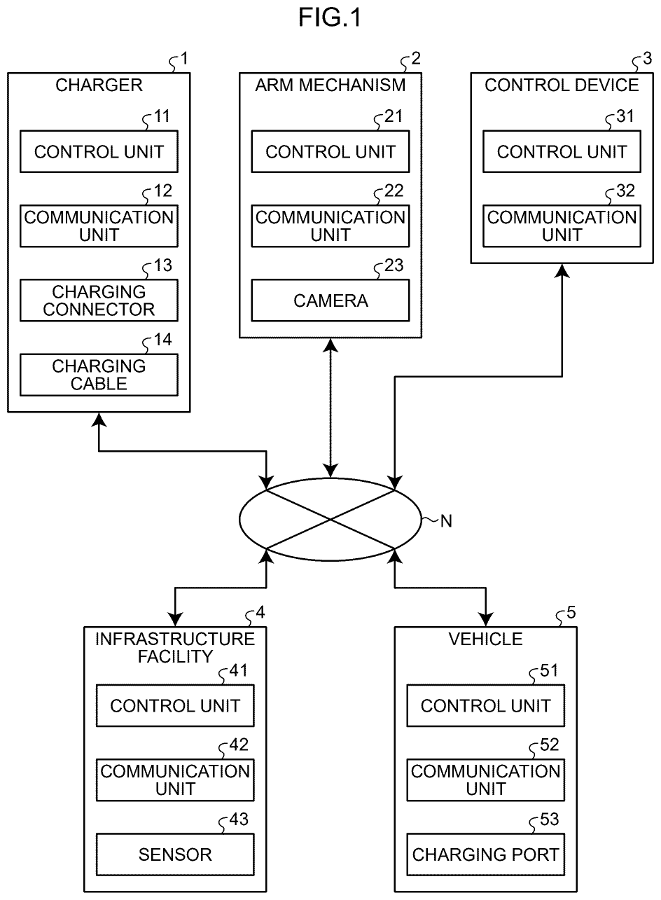

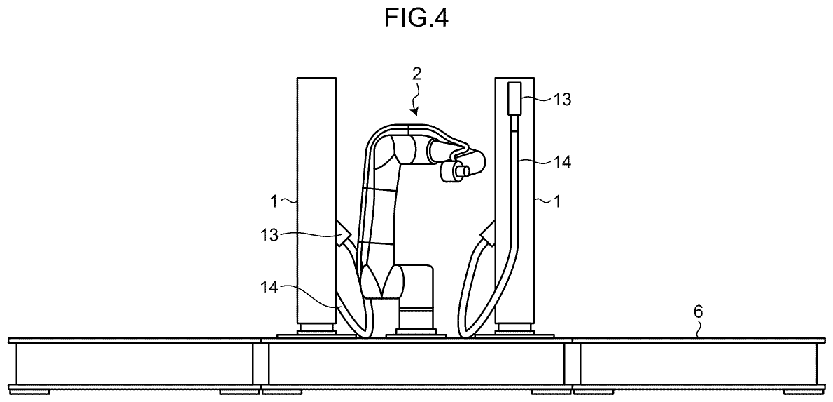

A charging system according to the embodiment will be described with reference to FIGS. 1 to 7. The charging system according to the embodiment, for example, using a charger installed in a parking lot or the like, is for charging a plurality of vehicles at the same time. The charging system according to the embodiment, as illustrated in FIG. 1, has a charger 1, the arm mechanism 2, the control device 3, the infrastructure facility 4, and the vehicle 5. The charger 1, the arm mechanism 2, the control device 3, the infrastructure facility 4 and the vehicle 5 are provided with a communication function, to communicate with each other through the network N, it is configured to be able to exchange various information. The network N is composed of, for example, the Internet line network, a mobile phone line network or the like.

### Charger

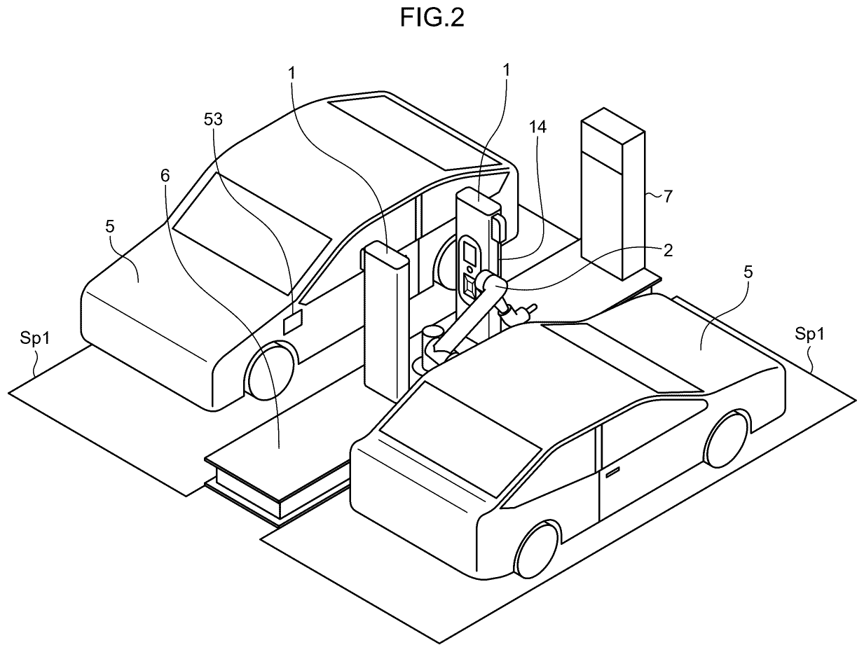

The charger (charging station, charging post) 1 is for supplying power to the vehicle 5 to be charged. The charger 1 is installed on the frame 6 as illustrated in FIGS. 2 to 4. Further, the charger 1 is connected to the control panel 7. The control panel 7 is connected to a substation facility (cubicle) or the like for transforming power from a power plant, for example.

The charger 1, as illustrated in FIG. 1, includes a control unit 11, a communication unit 12, a charging connector 13, and a charging cable 14.

The control unit 11, for example, is a processor made of a Central Processing Unit (CPU) or the like, a memory (main storage unit) consisting of a Random Access Memory (RAM) and a Read Only Memory (ROM) or the like. The control unit 11, based on an instruction from the control unit 3, supplies power to the vehicle 5 to be charged.

The communication unit 12 includes, for example, a Local Area Network (LAN) interface board, a wireless communication circuitry for wireless communication, and the like. The communication unit 12 communicates with, for example, the arm mechanism 2 and the control device 3 via the network N.

The charging connector (charging gun, charging plug) 13 is for supplying power to the vehicle 5 to be charged. The charging connector 13 is engaged with the side surface of the charger 1 during non-charging. Then, the charging connector 13, when charging to the vehicle 5 is started, is grasped by the arm mechanism 2 of the fixed type, and is inserted into the charging port 53 of the vehicle 5. In this state, through the charging connector 13, power is supplied from the charger 1 side to the vehicle 5 side. Thereafter, when charging to the vehicle 5 is completed, the charging connector 13 is again grasped by the arm mechanism 2, after being withdrawn from the charging port 53 of the vehicle 5, the charging connector 13 is engaged with the side surface of the charger 1.

In FIGS. 2 to 4, an example in the case where one charging connector 13 is provided for one charger 1 is illustrated, a plurality of charging connector 13 may be provided for one charger 1.

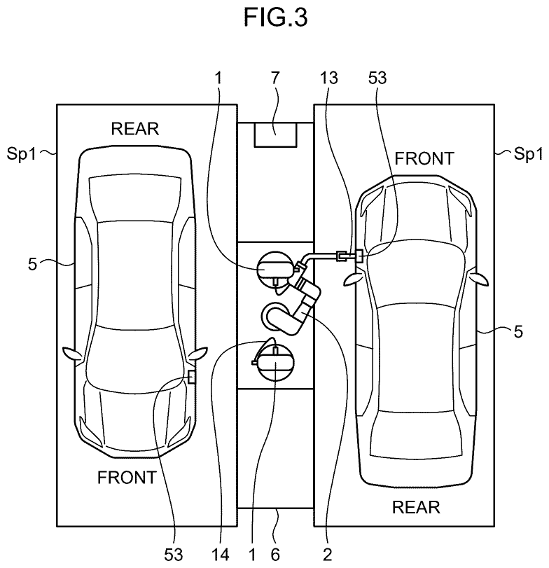

The charging cable 14 is provided between the charging connector 13 and the charger 1 (charger body). The charging cable 14, regardless of the position of the charging port 53 in the vehicle 5, is constituted by a length capable of inserting the charging connector 13 into the charging port 53. For example, FIG. 3 illustrates an example in which the charging port 53 is disposed on the left front of the vehicle 5, depending on the type of vehicle, the charging port 53 on the left side rear of the vehicle 5, the center front, there is a case where it is disposed on the center rear or the like. Therefore, the charging cable 14, the left front of the charging port 53 of the vehicle 5, the left rear, the center front, even when it is arranged in any of the center rear, the charging connector 13 is configured in a length that can be inserted.

Incidentally, depending on the vehicle type of the vehicle 5, the charging port 53 is the right front of the vehicle 5, there is a case that is disposed on the right rear. In this case, for example, in FIG. 3, parking the vehicle 5 of the left and right charging space Sp1 in the longitudinal opposite direction, respectively charging toward the charging port 53 in the direction of the charger 1. For example, the vehicle 5 on the right side of FIG. 3, the vehicle front is the lower paper, the vehicle rear is parked in the charge space Sp1 so as to face the upper paper surface. Further, the left vehicle 5, the vehicle front is on the paper, the vehicle rear is parked so as to face the paper surface lower.

### Arm Mechanism 2

The arm mechanism (automatic charging robot) 2, when performing charging from the charger 1 to the vehicle 5, is for grasping the charging connector 13. The arm mechanism 2 is capable of grasping a plurality of charging connector 13, to move each charging connector 13 in a predetermined range. The arm mechanism 2 is installed and fixed to the frame 6.

The arm mechanism 2, as illustrated in FIG. 1, includes a control unit 21, a communication unit 22, and a camera 23.

The control unit 21, for example, is realized by a processor made of a CPU or the like, a memory made of RAM or ROM or the like (main storage unit). The control unit 21, based on an instruction from the control unit 3, causes to grasp the charging connector 13, insert the charging connector 13 to the charging port 53, and withdraw the charging connector 13 from the charging port 53.

Further, the control unit 21, when inserting the charging connector 13 grasped to the charging port 53, for example, based on the image captured by the camera 23 installed at the tip of the arm mechanism 2, identifies the position of the charging port 53, the charging port 53 the distance to (the distance between the charging connector 13 and the charging port 53). The shape of the charging port 53 of the vehicle 5 is normalized. Therefore, the position of the charging port 53 can be identified by performing pattern matching based on the image of the charging port 53 captured by the camera 23. Further, the distance from the charging connector 13 grasped by the arm mechanism 2 to the charging port 53 can be specified by using a 3D (three-dimensional) camera as the camera 23 to acquire the information in the depth direction.

The position detection of the charging port 53 is not limited to the pattern matching described above. For example, the position of the charging port 53 may be detected by using a Ultra-Wide Band (UWB) communication with the vehicle 5 by obtaining the coordinates of the charging port 53. Alternatively, a paste QR cord (registered trademark) may be placed in the vicinity of the charging port 53 of the vehicle 5, so as to read the QR code (registered trademark) by the camera 23 installed at the distal end of the arm mechanism 2, for the position detection of the charging port 53.

The communication unit 22 is composed of, for example, a LAN interface board, a wireless communication circuit or the like for wireless communication. The communication unit 22 communicates with, for example, the charger 1 and the control device 3 through the network N.

The camera 23 is for imaging the charging port 53. The camera 23 is provided at the tip of the arm mechanism 2 (arm mechanism body). In embodiments, as the camera 23, a 3D camera capable of acquiring information in the depth direction is used.

### Control Device 3

The controller 3 is for controlling the charger 1, the arm mechanism 2 and a plurality of vehicles 5. The control device 3, for example, performs charging control of the charger 1, the control of the operation of the arm mechanism 2, the control of the infrastructure 4, the travel control of the vehicle 5 (control of movement) and the like. The controller 3 may be implemented, for example, by a general purpose computer such as a workstation or a personal computer, or by a server disposed on a cloud. Incidentally, the control device 3 may be constituted by separate hardware in accordance with the control target (charger 1, arm mechanism 2, infrastructure facility 4, vehicle 5). Further, of the control device 3, the control panel 7 may be responsible for a function of performing charging control of the charger 1.

The control device 3, as illustrated in FIG. 1 includes a control unit 31, and a communication unit 32.

The control unit 31, for example, is realized by a processor made of a CPU or the like, a memory made of a RAM or a ROM or the like (main storage unit). The following describes the specific processing contents of the control unit 31.

The control unit 31, based on the information obtained from the infrastructure facility 4 (e.g., position information of the vehicle 5, etc.), performs travel control of the vehicle 5. Further, the control unit 31, by controlling the vehicle 5 remotely, causes the vehicle 5 to move within a predetermined range (within the operating range of the arm mechanism 2).

For example, the control unit 31 receives the charging reservation of the vehicle 5 from the user of the vehicle 5 (e.g., the driver). The charging reservation may be accepted based on information input to the information terminal possessed by the user (for example, a smartphone or the like connected to the network N), or may be accepted based on information input to the in-vehicle terminal (for example, a car navigation or the like connected to the network N) by the user.

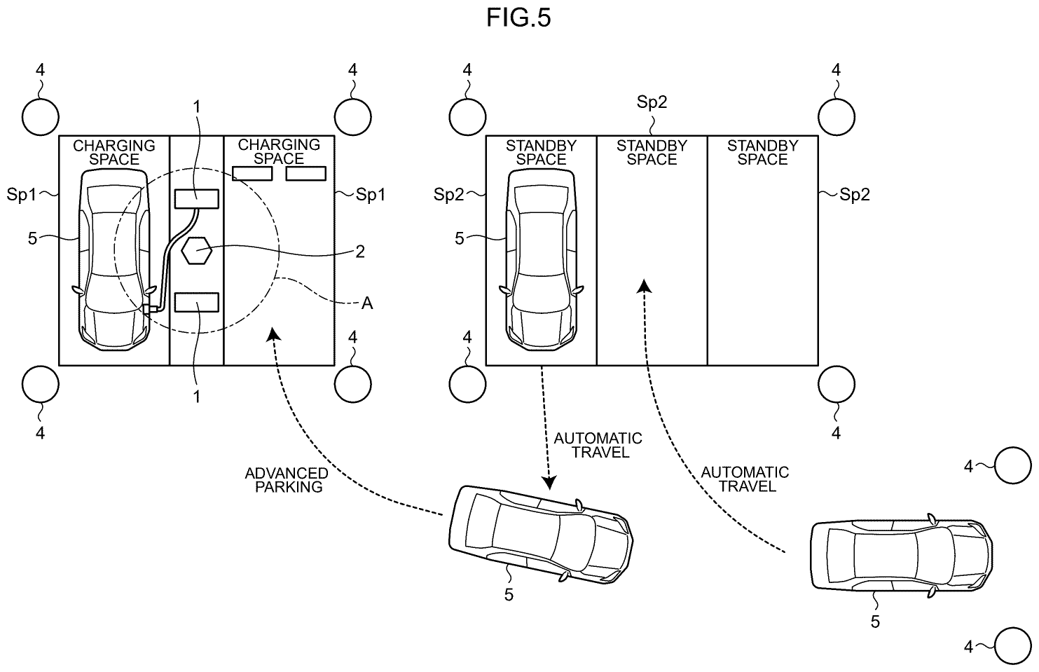

When the order of charging of the vehicle 5 is approaching, the control unit 31, as illustrated in FIG. 5, by using the positional information or the like of the vehicle 5 acquired from the infrastructure facility 4, causes the vehicle 5 to perform automatic traveling from the parking space in which the vehicle 5 is parked to the standby space Sp2, and then performs automatic parking. Thus, by waiting to move the vehicle 5 to be charged to the standby space Sp2 in advance, it is possible to minimize the replacement time of the vehicle 5 to perform charging, and it is possible to improve the operation rate of the charger 1.

Subsequently, when the order of charging the vehicle 5 arrives, the control unit 31, using the positional information and the like of the vehicle 5 acquired from the infrastructure facility 4, after causing the vehicle 5 to automatically travel from the standby space Sp2 to the charging space Sp1, causes the vehicle 5 to automatically park. Then, the control unit 31 causes the arm mechanism 2 to grasp the charging connector 13, and causes the charging connector 13 to be inserted into the charging port 53 to start charging by the charger 1.

Subsequently, when the charging of the vehicle 5 is completed, the control unit 31 causes again arm mechanism 2 to grasp the charging connector 13 to withdraw the charging connector 13 from the charging port 53. Subsequently, the control unit 31 causes the vehicle to automatically travel from the charging space Sp1 to the standby space Sp2 by using the positional information of the vehicle 5 acquired from the infrastructure facility 4, and causes the vehicle to automatically park there.

The control unit 31, when causing the vehicle 5 to parking in the charging space Sp1, causes the vehicle 5 to park in a manner that the charging port 53 faces the side of the charger 1. For example, when charging is performed on the vehicle 5 having the charging port 53 disposed on the left front as illustrated in FIG. 3, the control unit 31 causes the vehicle to park the vehicle 5 in a manner that the vehicle front side is directed to the upper side of the paper of the present application, and the vehicle rear side is directed toward the lower side of the paper, so that the charging port 53 is on the left in the charging space Sp1 on the right side of the charger 1. On the contrary, the control unit 31 causes the vehicle 5 to park the vehicle 5 in a manner that the vehicle front side is directed to the lower side of the paper of the present application, and the vehicle rear side is directed toward the upper side of the paper, so that the charging port 53 is on the right in the charging space Sp1 on the left side of the charger 1.

Incidentally, depending on the vehicle type of the vehicle 5, opposite to FIG. 3, there is a case where the charging port 53 is disposed on the right front or right rear of the vehicle 5. In this case, for example, in the example of two vehicles 5 illustrated in FIG. 3, the control unit 31 causes the vehicle 5 to park in a manner that the vehicle front side is directed to the lower side of the paper of the present application, and the vehicle rear side is directed toward the upper side of the paper, so that the charging port 53 is on the left in the charging space Sp1 on the right side of the charger 1. On the contrary, the control unit 31 causes the vehicle 5 to park in a manner that the vehicle front side is directed to the upper side of the paper of the present application, and the vehicle rear side is directed toward the lower side of the paper, so that the charging port 53 is on the right in the charging space Sp1 on the left side of the charger 1.

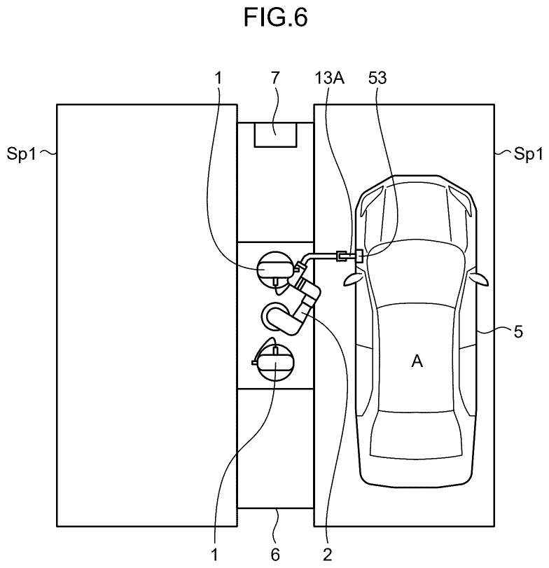

The control unit 31 simultaneously charges two or more vehicles 5 by operating the charging connector 13 using a single arm mechanism 2. In this instance, as illustrated in FIG. 6, the control unit 31 causes the first vehicle 5 (hereinafter, referred to as “vehicle A”) to move to a predetermined position (charge space Sp1 on the right side of the paper surface). Subsequently, the control unit 31 causes the arm mechanism 2 to grasp the charging connector 13A of the first charger 1 (charger 1 on the upper side of the paper). Subsequently, the control unit 31 causes the charging connector 13A grasped by the arm mechanism 2 to be inserted into the charging port 53 of the vehicle A to start charging of the vehicle A.

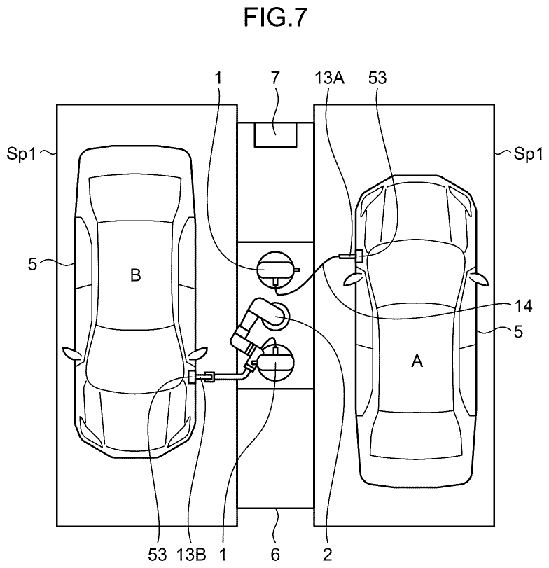

Subsequently, the control unit 31, as illustrated in FIG. 7, causes the second vehicle 5 (hereinafter, referred to as “vehicle B”) to move to a predetermined position (charge space Sp1 on the left side of the paper surface). Subsequently, the control unit 31 causes the arm mechanism 2 to grasp the charging connector 13B of the second charger 1 (charger 1 of the lower paper surface). Subsequently, during charging of the vehicle A, the control unit 31 causes the charging connector 13B grasped by the arm mechanism 2 to be inserted into the charging port 53 of the vehicle B to start charging of the vehicle B.

Thus, in the charging system according to the embodiment, by operating two or more charging connector 13A 13B by the single arm mechanism 2, it is possible to charge two or more vehicles 5 simultaneously. As a result, it is possible to increase the rotation rate of the charge.

In the embodiments of FIGS. 6 and 7, the control unit 31, before the vehicle A is stopped at a predetermined position (charging space Sp1 on the right side of the paper surface), may cause the arm mechanism 2 to grasp the charging connector 13A of the first charger 1 (charger 1 of the upper side of the paper surface) in advance to stand-by. Similarly, the control unit 31, before the vehicle B is stopped at a predetermined position (charging space Sp1 on the left side of the paper surface), may cause the arm mechanism 2 to grasp the charging connector 13B of the second charger 1 (charger 1 of the lower side of the paper surface) in advance for stand-by.

Further, in the embodiments of FIGS. 6 and 7, the “predetermined position” is a charge-space Sp1. Further, in the example of FIG. 6 and FIG. 7, when charging only one vehicle 5, the control unit 31 may cause the arm mechanism 2 to return to the predetermined standby position for standby after inserting the charging connector 13A (or charging connector 13B) to the charging port 53. Alternatively, the control unit 31 may cause the arm mechanisms 2 to return to the predetermined standby position after pulling out the charging connector 13A (or charging connector 13B) from the charging port 53. Further, for example, if there is no vehicle 5 waiting for the next charging or if there is no vehicle 5 where charging has been completed already, the control unit 31 may cause the arm mechanism 2 to return to a predetermined standby position.

Further, during charging of the first vehicle 5 (vehicle A), the control unit 31 may cause the second vehicle 5 (vehicle B) to move to an area where the charging connector 13B of the second charger 1 can be inserted by the arm mechanism 2. Thus, it is possible to quickly perform charging to the second vehicle 5.

Further, when the charging of the first vehicle 5 (vehicle A) is completed, the control unit 31 causes the arm mechanism 2 to move to the position of the charging port 53 of the first vehicle 5, after releasing the locking of the charging connector 13A, the control unit 31 causes the arm mechanism 2 to withdraw the charging connector 13A from the charging port 53 of the first vehicle 5. Further, when the charging of the second vehicle 5 (vehicle B) is completed, the control unit 31 causes the arm mechanism 2 to move to the position of the charging port 53 of the second vehicle 5, after releasing the locking of the charging connector 13B, the control unit 31 causes the arm mechanism 2 to withdraw the charging connector 13B from the charging port 53 of the second vehicle 5.

Thus, in the charging system according to the embodiment, by causing the arm mechanism 2 to grasp the charging connector 13A, 13B in advance before the vehicle 5 reaches the charging space Sp1, it is possible to further increase the rotational rate of charging.

Further, in the examples of FIG. 6 and FIG. 7, depending on whether the subsequent vehicle B is in the vicinity (whether it is possible to immediately charge the vehicle B), the control unit 31 may immediately determine whether to withdraw the charging connecter 13A, 13B from the vehicle A.

In this case, when the charging of the vehicle A is completed and the vehicle B is stopped at a predetermined position (charging space Sp1 on the left side of the paper), the control unit 31 causes the arm mechanism 2 to insert the charging connector 13B of the second charger 1 (charger 1 of the lower side of the paper surface) into the charging port 53 of the vehicle B to start charging. Then, the control unit 31 pulls out the charging connector 13A of the first charger 1 (charger 1 on the paper surface) from the charging port 53 of the vehicle A. That is, in a case where the charging to the vehicle A is completed, the vehicle B is stopped in the charging space Sp1, and if it is possible to immediately charge to the vehicle B, the control unit 31 puts a higher priority to insert the charging connector 13B into the vehicle B than to withdraw the charging connector 13A from the vehicle A.

On the other hand, in a case where the charging of the vehicle A is completed and the vehicle B is not stopped at a predetermined position (charging space Sp1 on the left side of the paper), the control unit 31 causes the arm mechanism 2 to remove the charging connector 13A of the first charger 1 (charger 1 of the upper side of the paper) from the charging port 53 of the vehicle A. Then, after the vehicle B is stopped at the predetermined position, the control unit 31 inserts the charging connector 13B of the second charger 1 (charger 1 of the paper surface lower) into the charging port 53 of the vehicle B to start charging. That is, in the case where the charging to the vehicle A is completed, if the vehicle B is not stopped in the charging space Sp1, and it is not possible to immediately charge to the vehicle B, the control unit 31 puts a higher priority to perform withdrawal of the charging connector 13A from the vehicle A than to the insertion of the charging connector 13B to the vehicle B.

Thus, in the charging system according to the embodiment, when operating a plurality of charging connector 13A, 13B by using the single arm mechanism 2, depending on the congestion of charging, it is determined whether the removal of the charging connectors 13A, 13B from the vehicle 5 or the insertion of the charging connectors 13A, 13B to the other vehicle 5 is to be performed. For example, when the charging is congested, if the charging connector 13A, 13B insertion is ready first, even if the completion time of unloading is delayed, a prioritize is put on the insertion into another vehicle 5. On the other hand, when the charging is not congested, after the removal of the charging connecter 13A, 13B, the insertion to another vehicle 5 is started.

Thus, in the charging system according to the embodiment, the operation of inserting the charging connector 13A, 13B to the plurality of vehicles 5 and the operation of the extraction of the charging connector 13A, 13B from the plurality of vehicles 5 are efficiently performed, and thus, it is possible to further increase the rotational rate of charging.

Further, in the charging system according to the embodiment, the stop position of the vehicle 5 in the charging space Sp1 may be optimized in consideration of various conditions. In this case, based on the, for example, an arm trajectory, and the shape of the vehicle 5, position of the charging port 53 of the vehicle 5, in the charging space Sp1, the control device 3 identifies the position of the vehicle 5 where the time when inserting the charging connector 13 into the charging port 53 (hereinafter, referred to as “connector insertion time”) is minimized. Subsequently, after causing the vehicle 5 to automatically travel to the specified position in the charging space Sp1 and to park thereon, the control device 3 causes the charging connector 13 grasped by the arm mechanism 2 to be inserted into the charging port 53 to start charging.

Herein the term “arm locus”, for example, as illustrated by A in FIG. 5, refers to the locus when the arm mechanism 2 grasps the charging connector 13. Since the arm locus is known, the control device 3 holds information about the arm locus in advance. In addition, the arm locus is, for example, a locus of a size including all the loci of the following (1) to (3):
(1) Trajectory of operation of the arm mechanism 2 when grasping the charging connector 13 locked to the side of the charger 1 before charging the vehicle 5;
(2) After (1), the locus of the operation of the arm mechanism 2 when inserting the grasped charging connector 13 into the charging port 53; and
(3) Locus of operation of the arm mechanism 2 when the charging connector 13 is withdrawn from the charging port 53 after charging of the vehicle 5.

The term “shape of the vehicle 5” refers to, for example, the body type of the vehicle 5 such as the classification of a sedan, a minivan, a wan box wagon, a mini-car, or the like. Information about the shape of the vehicle 5 is included in the reservation information to be acquired when the control device 3 receives the reservation of charging.

Further, the term “position of the charging port 53”, as described above, refers to, for example, the left front, left rear, right front, right rear, center front, center rear, and the like of the vehicle 5. The information about the position of the charging port 53 is included in the reservation information to be acquired when the control device 3 accepts the reservation of charging.

Further, the “connector insertion time” refers to, for example, the time obtained by summing the following (1) and (2):
(1) Time from when the vehicle 5 stops at Sp1 the charging space until when the arm mechanism 2 grasps the charging connector 13 which is locked to the side of the charger 1; and
(2) Time from when the charging connector 13 is grasped until when insertion into the charging port 53 and locking to the charging connector 13 are done.

Note that the connector insertion time varies depending on the position of the shape and the charging port 53 of the vehicle 5. For example, a case is considered where both the large wagon box wagon and a small mini-car (e.g., front center) have the respective charging ports 53 at the same positions thereof, and two of the vehicles are at the same position of the charging space Sp1. In this case, the distance from the arm mechanism 2 to the charging port 53 of the wagon box wagon is longer than the distance from the arm mechanism 2 to the charging port 53 of the light vehicle. Therefore, the time required when the arm mechanism 2 grasps the charging connector 13 to charge the wagon by is longer than the time required when the arm mechanism 2 grasps the charging connector 13 to charge the light vehicle.

Therefore, based on the arm trajectory, the shape of the vehicle 5, and the position of the charging port 53 of the vehicle 5, the control device 3 specifies the position of the vehicle 5 where the connector insertion time is minimized and causes the vehicle 5 to park at that position. Thus, in the charging system according to the embodiment, by stopping the vehicle 5 so that the charging port 53 is in a state as close as possible to the arm mechanism 2, it is possible to quickly charge regardless of the shape and the position of the charging port 53 of the vehicle 5.

Incidentally, the control device 3 may specifies the position of the vehicle 5 where the distance from the charging port 53 to the position to grasp the charging connector 13 is minimized, instead of the position of the vehicle 5 where the connector insertion time is minimized, and causes the vehicle 5 to park at the position. In this case, the control device 3 specifies the position of the vehicle 5 at which the distance from the position where the charging connector 13 is grasped to the charging port 53 is minimized based on, for example, the arm trajectory, the shape of the vehicle 5, the position of the charging port 53 of the vehicle 5, and the position where the charging connector 13 is grasped. The term “position where the charging connector 13 is grasped” refers to, for example, a position where the charging connector 13 is locked in the side surface of the charger 1.

Further, the control device 3 may determine the timings to move of the vehicle 5 in each space (parking space, standby space Sp2, the charging space Sp1) based on the arm trajectory, the shape of the vehicle 5, and the position of the charging port 53 of the vehicle 5, and may move the vehicle 5 at the determined timings.

Thus, in the charging system according to the embodiment, the stop position and the timings of moving the vehicle 5 in the charging space Sp1 are optimized, while the charging connector 13 is grasped by the arm mechanism 2 in a manner that the charging connector 13 does not contact with the vehicle 5 to stand by close. Thus, it is possible to minimize the connector insertion time, it is possible to shorten the charging time per vehicle, and it is possible to increase the rotation rate of charging. Further, since the replacement time of the vehicle 5 in the charging space Sp1 can be minimized and the waiting time for charging of the user can also be shortened, the profitability in developing the charging to the vehicle 5 as a business can be improved.

Further, regardless of the shape of the vehicle 5, in order to prevent interference between the vehicle 5 and the arm locus, it is desired to secure a large space occupied by the frame 6 to install the charger 1. Therefore, in the charging system according to the embodiment, by operating the arm mechanism 2 in consideration of the shape of the vehicle 5, it is possible to minimize the occupied space. Further, by matching the operation of the arm mechanism 2 and the timing of the stop of the vehicle 5, it is possible to shorten the charging time per vehicle. Furthermore, since it is also possible to minimize the required reach of the arm mechanism 2, it is possible to miniaturize the arm mechanism 2, and it is possible to minimize the width of the frame 6.

Further, in the charging system according to the embodiment, in addition to the optimization of the stop position of the vehicle 5 as described above, the order of charging of the vehicle 5 in the charging space Sp1 may be optimized. In this case, the control device 3 receives the charging reservation of each vehicle 5 from the user of the plurality of vehicles 5. Subsequently, in a case where continuous charging to the vehicles 5 is performed, the control device 3 determines the order of charging to the vehicles 5 in which the operation time of the arm mechanism 2 (hereinafter, “arm operation time”) is minimized based on the arm locus, the shape of each vehicle 5, and the position of the charging port 53 of each vehicle 5. Subsequently, based on the determined order of the charging, the control device 3 causes the vehicles 5 to sequentially automatically move and stop to the specific position of the above (the position of the vehicle 5 the connector insertion time is the minimum).

Here, the term “arm operation time” refers to, for example, the time obtained by summing the following (1) to (4):
(1) Time from when the vehicle 5 stops Sp1 the charging space until when the arm mechanism 2 grasps the charging connector 13 which is locked to the side of the charger 1;
(2) Time from when the charging connector 13 is grasped to when the insertion into the charging port 53 to lock the charging connector 13;
(3) Time from unlocking the charging connector 13 to pulling out the charging connector 13 from the charging port 53; and
(4) Time until the removed charging connector 13 is locked to the side surface of the charger 1.

Further, the term “arm operation time is minimized” refers to that the sum of the operation time of the arm mechanism 2 when plugging and unplugging the charging connector 13 for a plurality of vehicles 5 is minimum. Therefore, minimizing the arm operation time is synonymous with minimizing the overall charging time for a plurality of vehicles 5.

Thus, in the charging system according to the embodiment, by determining the order of charging of the vehicle 5 so as to minimize the arm operation time, it is possible to shorten the charging time per vehicle, and it is possible to increase the rotation rate of charging. Incidentally, in the case of performing the charging to each vehicle 5 continuously, the control device 3 may determine the location of charging to the vehicles 5 where the arm operation time is minimized based on the arm trajectory, the shape of each vehicle 5, and the position of the charging port 53 of each vehicle 5.

The communication unit 32 includes, for example, a Local Area Network (LAN) interface board, a wireless communication circuitry for wireless communication, and the like. The communication unit 32 communicates with, for example, the charger 1, the arm mechanism 2, the infrastructure facility 4 and the vehicle 5 through the network N.

### Infrastructure Facilities 4

The infrastructure facility 4 is provided for realizing, for example, automatic travel of the vehicle 5 in the parking lot, and automatic parking by advanced parking (advanced parking support function). The infrastructure facility 4 is arranged, for example, as illustrated in FIG. 5, around the charging space Sp1 of the vehicle 5, around the standby space Sp2 of the vehicle 5, on the traveling route of the vehicle 5 (such as on both sides of the traveling route) and the like.

The infrastructure facility 4 includes a control unit 41, a communication unit 42, and a sensor 43, as illustrated in FIG. 1.

The control unit 41 is realized by, for example, a processor made of a CPU or the like, a memory made of a RAM or a ROM, or the like (main storage unit). The control unit 41 transmits, for example, information about the position of the vehicle 5 detected by the sensor 43 and the like to the control device 3.

The communication unit 42 includes, for example, a Local Area Network (LAN) interface board, a wireless communication circuitry for wireless communication, and the like. The communication unit 42 exchanges information between, for example, the control device 3 and the vehicle 5 via the network N.

The sensor 43 is realized by, for example, a Light Detection and Ranging, Laser Imaging Detection and Ranging (LiDAR), a camera, or the like.

### Vehicle 5

The vehicle 5 is, for example, a Plug-in Hybrid Electric Vehicle (PHEV), an electric vehicle which can be powered such as a Battery Electric Vehicle (BEV). The vehicle 5 may be, for example, an autonomously travelable automated driving vehicle without operation by the driver. Further, the vehicle 5 may have an automatically parking function and a parking assistance function for assisting automatic parking.

The vehicle 5, as illustrated in FIG. 1, includes a control unit 51, a communication unit 52, and a charging port 53. In FIG. 1, among the configurations of the vehicle 5, only the configuration for realizing the power supply system according to the embodiment is illustrated, and other configurations are not shown.

The control unit 51 is an Electronic Control Unit (ECU) including, for example, a microcomputer having a CPU, RAM, ROM, or the like as main components. The control unit 51 comprehensively controls the operation of various components of the vehicle 5 by executing various programs.

The control unit 51 performs, for example, an automatic travel in the parking lot and automatic parking based on an instruction from the control device 3. For example, when the charging reservation by the charger 1 is made, the user of the vehicle 5 operates the vehicle 5 to the parking lot in which the charger 1 is installed to park in the parking space in the parking lot. Then, the user opens the cover of the charging port 54 when getting off the vehicle 5 (hereinafter, referred to as “charging port cover”) and leaves the parking space.

When the order of charging the vehicle 5 is approaching, in accordance with an instruction from the control unit 3, after automatically traveling the vehicle 5 from the parking space to the standby space Sp2, the control unit 51 causes the vehicle 5 to automatically parking. Subsequently, when the order of charging the vehicle 5 arrives, in accordance with an instruction from the control unit 3, after automatically traveling the vehicle 5 from the standby space Sp2 to the charging space Sp1, the control unit 51 causes the vehicle 5 to automatically park. Then, the charging connector 13 grasped by the arm mechanism 2 is inserted into the charging port 53 to start charging.

Subsequently, when the charging is completed, the charging connector 13 is withdrawn from the charging port 53 by the arm mechanism 2.

Subsequently, the control unit 51, in accordance with an instruction from the control unit 3, after automatically traveling the vehicle 5 from the charging space Sp1 to the standby space Sp2, to automatically park.

The communication unit 52 is composed of, for example, a Data Communication Module (DCM), or the like. The communication unit 52 exchanges information among, for example, the charger 1, the arm mechanism 2, the control device 3, and the infrastructure facility 4 through the network N.

The charging port (inlet) 53 is provided for receiving power from the charger 1. The charging port 53, by the charging connector 13 of the charger 1 is inserted, the power from the charger 1, to store the battery of the vehicle 5 (not shown). The charging port 53, in the examples of FIGS. 2 to 4, is disposed on the left front of the vehicle 5. The charging port 53, however, may be disposed on the left rear, right front, right rear, center front, center rear, or the like of the vehicle 5.

The frame 6 is installed in, for example, a parking lot or the like where the vehicles 5 can be gathered. The frame 6 can be installed in any parking such as a self-propelled multilevel parking lot, regardless of the type of parking, for example, a flat parking, and a mechanical steric parking. Further, the frame 6, as illustrated in FIGS. 2 to 4, is equipped with the charger 1, the arm mechanism 2, and the control panel 7. Further, in the present embodiment, two chargers 1 are installed on the frame 6, so that it is configured to be charged simultaneously for two or more vehicles 5.

When the charger 1 is installed in a parking lot, the installation is carried out for each frame. That is, the charger 1, the arm mechanism 2 and the control panel 7 are installed to the frame 6 in advance in a factory or the like, after the adjustment of the operation of the arm mechanism 2 (robot teaching), the alignment of the charger 1 and the arm mechanism 2, the wiring work or the like are completed, each frame 6 is transported to the parking lot and the installation (e.g. anchor fixing) is done. By performing the installation as such for each frame, the degree of freedom in installation of the charger 1 and the arm mechanism 2 is improved, and it is possible to minimize the construction cost.

### How to Charge

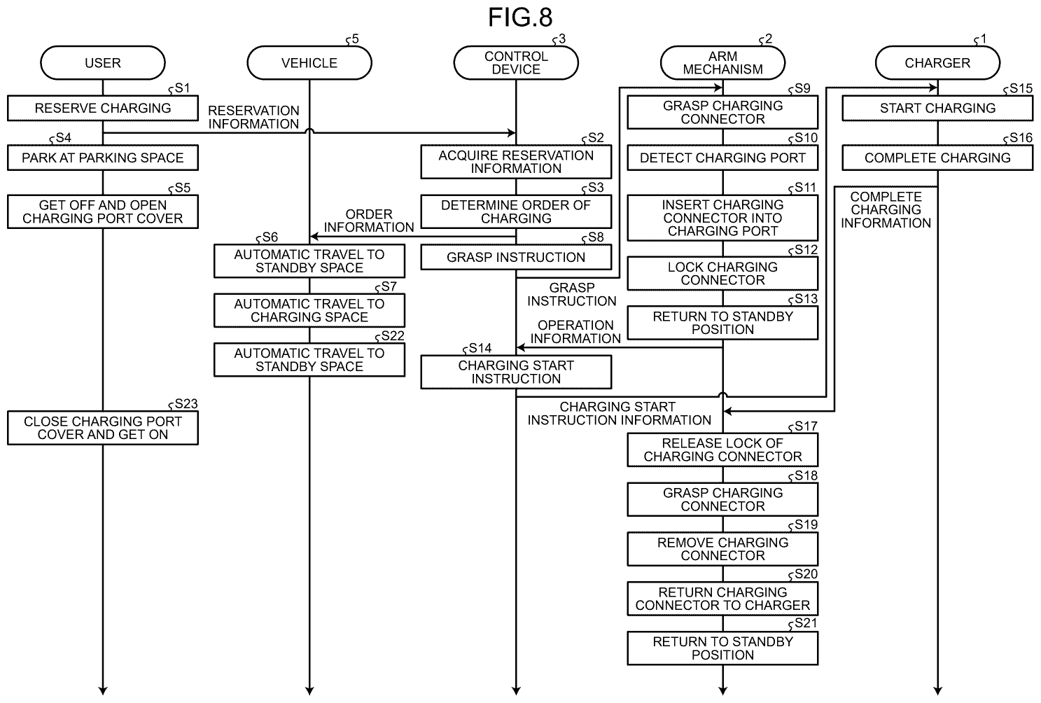

The flow of the charging method the charging system according to the embodiment executes will be described with reference to FIG. 8.

First, the user makes a charge reservation (step S1). The charging reservation may be performed, for example, through an information terminal carried by the user (e.g., a smartphone connected to the network N, etc.), or may be performed through a vehicle-mounted terminal (e.g., a car navigation connected to the network N, etc.).

Subsequently, the control unit 3 acquires the reserved information of the charge from the information terminal or the in-vehicle terminal or the like of the above (step S2). This reservation information includes information necessary for charging the vehicle 5 by the charger 1.

The reservation information includes, for example, information for specifying a user (for example, a user ID, etc.), information on the transmission date and time of the charge reservation, information on the date and time desired to charge, and the like. In addition, the reservation information further includes information for specifying the vehicle 5 (e.g., vehicle number, etc.), the shape of the vehicle 5 (body type), information about the position of the charging port 53 of the vehicle 5, information about the remaining battery capacity of the vehicle 5 (State Of Charge (SOC)), the present position of the vehicle 5, and the like. Incidentally, the term “information about the position of the charging port 53” refers to the position where the charging port 53 is arranged on, for example, the left front, the left rear, the right front, the right rear, or the center front of the vehicle 5.

Subsequently, the control device 3 determines the order of charging of the vehicles 5 or which the reservation is made (step S3). In step S3, the order of charging the vehicles 5 is determined based on, for example, the number of other vehicles 5 that have received the charging reservation at the same time or before and after the time, the predicted time from when the remaining battery capacity of the other vehicle 5 to the charging completion. Further, in step S3, the control device 3 transmits the information about the determined order (order information) to the vehicle 5 (and, for example, the information terminal of the user and the in-vehicle terminal).

Subsequently, the user parks the vehicle 5 in the parking space of the parking lot (parking lot charger 1 is installed) (step S4). Subsequently, after getting out of the car 5, the user opens the charge port cover (step S5) and leaves the parking space.

Subsequently, the vehicle 5 automatically travels from the parking space to the standby space Sp2 based on an instruction of the control device 3 (step S6). Then, when the order of charging arrives, the vehicle 5 automatically travels from the standby space Sp2 to the charging space Sp1 based on an instruction of the control device 3 (step S7).

When the vehicle 5 is stopped in the charging space Sp1, the control device 3 transmits an instruction to grasp the charging connector 13 (grasp instruction) to the arm mechanism 2, (step S8). In response, the arm mechanism 2 grasps the charging connector 13 (step S9) to move the charging connector 13 to the vicinity of the charging port 53. Subsequently, the arm mechanism 2 detects the position of the charging port 53 by, for example, pattern matching or the like based on the image of the charging port 53 (step S10), and inserts the charging connector 13 to the charging port 53 (step S11).

Subsequently, the arm mechanism 2 locks the charging connector 13 by a locking mechanism (not shown) or the like, so that the charging connector 13 is not disengaged from the charging port 53 (step S12), and releases the grip of the charging connector 13 to be returned to a predetermined standby position (step S13).

The term “predetermined standby position” refers to, for example, as illustrated in FIG. 1, a position where the entire arm mechanism 2 is within the range of the frame 6 (position not protruding from the frame 6) and the like. Further, in step S13, the arm mechanism 2 transmits the information related to the current operation status of the arm mechanism 2 (e.g., the current position, the presence or absence of locking of the charge connector 13, etc.) to the control device 3.

Here, the case where the arm mechanism 2 returns to the predetermined standby position as in step S13 refers to, for example, a case where there is no other vehicle 5 waiting for charging next, or a case where there is no other vehicle 5 that has already been charged. For example, if there is another vehicle 5 waiting for the charge next, the arm mechanism 2 does not return to the predetermined standby position (without performing step S13), the process from the step S9 is performed on the other vehicle 5. Further, for example, if there is another vehicle 5 that has already been charged for the next time, the arm mechanism 2 does not return to the predetermined standby position (without performing step S13), the process from step S17 is performed on the other vehicle 5.

Subsequently, the control device 3 transmits the information for instructing the start of charging from the charger 1 to the vehicle 5 (charging start instruction information) to the charger 1 (step S14). Subsequently, the charger 1 starts charging the vehicles 5 (step S15). Subsequently, the charger 1, when the charging of the vehicle 5 is completed (step S16), transmits the information indicating that the charging is completed (charging completion information) to the arm mechanism 2.

Subsequently, the arm mechanism 2 unlocks the charging connector 13 (step S17), grasps the charging connector 13 (step S18), and withdraws charging connector 13 from the charging port 53 (step S19). Subsequently, the arm mechanism 2 returns the withdrawn charging connector 13 to a predetermined position of the charger 1 (e.g., the side of the charger 1) (step S20), and releases the grip of the charging connector 13 to return to a predetermined standby position (step S21).

Here, the case where the arm mechanism 2 returns to the predetermined standby position as in step S21 refers to, for example, a case where there is no other vehicle 5 waiting for charging next, or a case where there is no other vehicle 5 that has already been charged completed. For example, if there is another vehicle 5 waiting for the charge next, the arm mechanism 2 does not return to the predetermined standby position (without performing the step S21), the process after the step S9 is performed on the other vehicle 5 as it is. Further, for example, when there is another vehicle 5 that has already been charged for the next time, the arm mechanism 2 does not return to the predetermined standby position (without performing step S21), the process after step S17 is performed on the other vehicle 5.

Subsequently, the vehicle 5 automatically travels from the charge space Sp1 to the standby space Sp2 on the basis of an instruction of the control device 3 (step S22). Subsequently, the user closes the charging port 53 in the waiting space Sp2, rides on the vehicle 5 (step S23), and leaves the parking lot.

Although not illustrated in FIG. 8, in the scene where the vehicle 5 automatically travels in the steps S6, S7, and S22, due to the continuous communications between the control device 3 and the vehicle 5, automatic travel is realized. In this instance, while specifying the position of the vehicle 5 based on, for example, the information acquired from the infrastructure facility 4, the control device 3 sequentially transmits, for example, the position of the standby space Sp2 and the charging space Sp1, the standby space Sp2 and the driving route to the charging space Sp1. and the like to the vehicle 5. Thus, the control device 3 controls the travel of the vehicle 5 in the parking lot.

In the charging system according to the embodiment described above, a plurality of charging connector 13 are operated by one fixed arm mechanism 2, to charge a plurality of vehicles 5 simultaneously. At that time, since the arm mechanism 2 itself cannot be moved, by moving the vehicle 5 during charging by inserting the charging connector 13, it is possible to charge a plurality of vehicles 5 at the same time.

Thus, according to the charging system according to the embodiment, it is possible to simultaneously charge the two or more vehicles 5 by a simple configuration, and it is possible to increase the rotation rate of charging. As a result, it is possible to shorten the waiting time for charging of the user, and it is possible to improve the profitability when developing the charging to the vehicle 5 as a business. In the charging system according to the embodiment, since the automatic traveling of the vehicle 5 and the charging is performed using the automatic parking, the charging wait of the user is not required, thereby improving the convenience of the user.

Further effects and variations can be readily derived by one skilled in the art. Thus, the broader aspects of the disclosure are not limited to the specific details and representative embodiments represented and described above. Accordingly, various modifications are possible without departing from the overall inventive concept or scope defined by the appended claims and their equivalents.

According to the present disclosure, regardless of the position of the charging port of the vehicle and the type of parking lot, it is possible to simultaneously charge the two or more vehicles by a simple configuration, and it is possible to increase the rotation rate of charging.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A charging system comprising:
a charger having a charging connector;
an arm mechanism that grasps the charging connector; and,
a control device for controlling the charger, the arm mechanism and a plurality of vehicles, wherein
the control device configured to
identify positions of the vehicles where a time for inserting the charging connector into charging ports of the vehicles is minimized based on an arm locus illustrating a locus when the arm mechanism grasps the charging connector, shapes of the vehicles, and positions of the charging ports of the vehicles,
cause the vehicles to automatically travel to the identified positions and park therein, and
insert the charging connector grasped by the arm mechanism into the charging ports to start charging.

2. The charging system according to claim 1, wherein
the control device further configured to
receive charging reservations from the vehicles,
determine, in a case where charging is sequentially performed on the vehicles, an order of charging the vehicles so that a time for operating the arm mechanism for the vehicles is minimized based on the arm locus, the shapes of the vehicles, and the positions of the charging ports of the vehicles, and
cause the vehicles to automatically travels to the identified positions and park therein.
